(19) United States
(12) Patent Application Publication
(10) Pub. No.: US 2019/0250938 A1
(43) Pub. Date: Aug. 15, 2019

(54) COMPUTER SYSTEM ARCHITECTURE AND COMPUTER NETWORK INFRASTRUCTURE INCLUDING A PLURALITY OF SUCH COMPUTER SYSTEM ARCHITECTURES

(71) Applicant: Fujitsu Technology Solutions Intellectual Property GmbH, München (DE)

(72) Inventors: Heinz-Josef Claes, München (DE); Robert Ferwagner, München (DE)

(21) Appl. No.: 16/098,286

(22) PCT Filed: Oct. 11, 2017
(86) PCT No.: PCT/EP2017/075980

§ 371 Date: Nov. 1, 2018

(30) Foreign Application Priority Data
Oct. 18, 2016 (DE) 10 2016 119 802.1
Dec. 14, 2016 (DE) 10 2016 124 383.3

(51) Int. Cl. G06F 9/455; H04L 29/06

(52) U.S. Cl. CPC G06F 9/45558; G06F 2009/45583; G06F 2009/45595; H04L 63/0272

(57) ABSTRACT

A computer system architecture, wherein a virtual machine and a virtual network bridge are controllable by a basic operating system, the virtual machine is linked to the virtual network bridge and set up for communication with further virtual machines within a virtual communication subnetwork, establishment of a connection from the virtual machine to an external physical network outside the physical computer system, which has a different configuration than the virtual communication subnetwork, is prevented, and the network ports of the physical computer system are set up such that relaying of a communication between the virtual machine and other virtual machines within the virtual communication subnetwork beyond the physical computer system by the external physical network (N, N1, N2) is permitted, but establishment of a connection from the external physical network from outside the physical computer system to the physical computer system independently of the virtual communication subnetwork is prevented.

### TECHNICAL FIELD

This disclosure relates to a computer system architecture comprising a physical computer system on which a basic operating system and a virtual environment are set up as well as a computer system infrastructure having a plurality of such computer system architectures.

### BACKGROUND

Safe operation of operating systems and application programs running thereon or application programs is always a technical problem or a challenge in modern computer system architectures or in computer network infrastructures or IT networks comprising a plurality of such computer system architectures.

A great problem for the security of computer system architectures or entire computer network infrastructures is the occurrence and exploitation of errors, of what are known as “backdoors,” “zero day exploits” or other security gaps in the operating systems to be operated or the application programs running on the operating systems. Such errors and security gaps can be exploited by attackers from an external network to perform manipulation of an operating system, application programs running thereon or data processed in the operating system or in the application programs running thereon. Furthermore, attackers can also exploit errors and security gaps for unauthorized access to operating systems, application programs and data.

A further problem in connection with the security of IT systems is that operating systems or application programs acquirable from third parties may be erroneous or may be consciously manipulated or set up, or are manipulated by an external attacker such that they perform establishment of a connection that a user does not want to other external systems (referred to as “phoning home” in technical circles) to forward data or, generally, information to third parties (for example, criminals). A user often has no knowledge or even the possibility of knowledge of such processes. It is also known that such processes are deliberately veiled to not attract attention as far as possible or very much.

Against the background of a system security that must be stringently demanded, it is thus necessary for operating systems and application programs running thereon to be classified as “potentially unsafe” in principle. A similar situation applies to other hardware and software components used in IT networks.

Conventional security solutions provide for the use of firewall systems ideally connected between all of the systems and components or the interfaces thereof in a computer network infrastructure to control and restrict the network traffic of the operating systems or the application programs running thereon and the connections between computer systems involved and other network components (e.g., routers, switches or the like) and therefore to reduce the risk of improper data traffic via unwanted network connections as far as possible.

A disadvantage of those approaches hitherto, however, is that a multiplicity of security rules need to be set up for each operating system or each application program running thereon in principle to make the computer system as robust as possible toward attacks from the network or toward an unwanted withdrawal of data to an external system. When there are a multiplicity of application programs within a complex computer network infrastructure (e.g., company or group network), security management using firewall settings thus quickly becomes confusing and susceptible to error. Administration of firewall systems is also very time-consuming and expensive because the firewall settings need to be continuously updated, i.e., examined, revised and possibly improved, after software updates to counter the risks of the type explained above. Further, firewall systems may also have errors, backdoors or security gaps generally and can be manipulated by users (e.g., administrators) for improper access to data that need to be protected.

It is additionally known practice to set up operating systems or application programs within a virtual environment that are able to be controlled via a basic operating system, e.g., by what is known as a “hypervisor.” Virtual environments of this kind are appropriate, by way of example, to initially test particular software packages in a protected environment (what is known as a sandbox) before corresponding programs are used within a larger network. Such sandbox environments are used only for testing software, however, and are impractical for realizing complex IT networks.

On the other hand, virtualization solutions can be used to network a wide variety of systems to one another in a flexible and simple manner, with limitations by physical hardware being able to be kept small. In this case, virtualized systems within virtual machines within virtual environments are put onto one or more physical computer systems. However, even when virtualized systems of this kind are used in IT networks, the risks of the type explained above arise on account of the virtual systems being linked to one or more physical networks.

It could therefore be helpful to provide a computer system architecture and a computer network infrastructure having a plurality of such computer system architectures that allow increased security for the systems constructed thereby, have improved robustness toward the risks demonstrated above and nevertheless provide the possibility of setting up a flexible and application-oriented infrastructure in particular in larger networks.

### SUMMARY

We provide a computer system architecture including a physical computer system on which a basic operating system and a virtual environment are set up, wherein the virtual environment has at least one virtual machine and at least one virtual network bridge of at least one virtual communication subnetwork, the virtual machine and the virtual network bridge are controllable by the basic operating system, the virtual machine is linked to the virtual network bridge and set up for communication with further virtual machines within the virtual communication subnetwork, the virtual machine is further set up such that establishment of a connection from the virtual machine to an external physical network outside the physical computer system, which has a different configuration than the virtual communication subnetwork, is prevented, and the network ports of the physical computer system are set up such that relaying of a communication between the virtual machine and other virtual machines within the virtual communication subnetwork beyond the physical computer system by the external physical network (N, N1, N2) is permitted, but establishment of a connection from the external physical network from outside the physical computer system to the physical computer system independently of the virtual communication subnetwork is prevented.

We also provide a computer network infrastructure including a plurality of computer system architectures including a physical computer system on which a basic operating system and a virtual environment are set up, wherein the virtual environment has at least one virtual machine and at least one virtual network bridge of at least one virtual communication subnetwork, the virtual machine and the virtual network bridge are controllable by the basic operating system, the virtual machine is linked to the virtual network bridge and set up for communication with further virtual machines within the virtual communication subnetwork, the virtual machine is further set up such that establishment of a connection from the virtual machine to an external physical network outside the physical computer system, which has a different configuration than the virtual communication subnetwork, is prevented, and the network ports of the physical computer system are set up such that relaying of a communication between the virtual machine and other virtual machines within the virtual communication subnetwork beyond the physical computer system by the external physical network (N, N1, N2) is permitted, but establishment of a connection from the external physical network from outside the physical computer system to the physical computer system independently of the virtual communication subnetwork is prevented, connected via at least one physical network, wherein at least one virtual machine of the respective computer system architectures connects to at least one virtual machine of at least one other computer system architecture via at least one virtual communication subnetwork, and the computer network infrastructure is set up such that a communication within the at least one virtual communication subnetwork is relayed between the physical computer systems by the at least one physical network.

### BRIEF DESCRIPTION OF THE DRAWINGS

FIG. 1 shows a schematic depiction of a particular functionality of a computer system architecture for use in a computer network infrastructure.

FIG. 2 shows a schematic depiction of a further functionality of a computer system architecture.

FIG. 3A shows a schematic depiction of an example of a computer network infrastructure having two computer system architectures.

FIG. 3B shows an equivalent circuit diagram for the functionality shown in FIG. 3A.

FIG. 3C shows a schematic depiction of a further functionality of a computer system architecture within a computer network infrastructure.

FIG. 4 shows a schematic overall view of various functionalities of the computer system architectures within a computer network infrastructure as shown in FIG. 3A.

FIG. 5A shows a schematic depiction of a further example of a computer network infrastructure in a first configuration.

FIG. 5B shows the example shown in FIG. 5A in a second configuration.

FIG. 6A shows a further example of a computer network infrastructure.

FIG. 6B shows an equivalent circuit diagram for the functionality shown in FIG. 6A.

FIG. 7A shows a simplified depiction of the example shown in FIG. 6A.

FIG. 7B shows a further example of a computer network infrastructure.

FIG. 7C shows a schematic depiction of protected connections between physical computer systems in a computer network infrastructure.

FIG. 8 shows a further example of a computer network infrastructure.

### LIST OF REFERENCE SIGNS

1, 1a to 1f Computer system architecture
2, 2a to 2f Physical computer system
3, 3a to 3c Virtual communication subnetworks
31, 32, 33, 34 Virtual communication subnetworks
4, 4a to 4f Network ports
14, 24 Network ports
5 Virtual storage subnetwork
6 Entity of a basic operating system
7 Administration computer system
8 Broker computer system
9a, 9b High-security rack
10 Relay system
11 Routing
12a, 12b VPN service
13a, 13b VPN connections
VM1 to VM4 Virtual machine
Br Virtual network bridge
N, N1, N2 Physical network
NI, NII Physical network
Cs Console of a virtual machine
FW Firewall
web1, web2 Web server
app1, app2 Application server
db1, db2 Database server
VM-Struct. Virtual structure
L1 to L4 Storage components

### DETAILED DESCRIPTION

Our computer system architecture comprises a physical computer system on which a basic operating system and a virtual environment are set up. The virtual environment has at least one virtual machine and at least one virtual network bridge of at least one virtual communication subnetwork. The virtual machine can comprise, by way of example, a virtualized operating system to be operated and one or more virtualized application programs running on the operating system. Generally, the term “virtual machine” or “virtual environment” is understood as an environment abstracted and possibly separated from the basic operating system and from the hardware of the physical computer system.

The virtual machine and the virtual network bridge are controllable by the basic operating system. Such control is advantageously effected via a hypervisor of the basic operating system, which hypervisor is set up to control the virtual machine and the virtual network bridge. The virtual machine is linked to the virtual network bridge and set up for communication with further virtual machines within the virtual communication subnetwork or other virtual communication subnetworks.

The virtual machine is further set up such that establishment of a connection from the virtual machine to an external physical network outside the physical computer system having a different configuration from the virtual communication subnetwork, is prevented. This means that the virtual machine can only communicate within the virtual communication subnetwork(s), possibly also across different virtual communication subnetworks, that is to say can accept connections from other virtual machines or can establish connections to other virtual machines, but does not have a connection or an interface to an external physical network outside the physical computer system. Applicable control of the virtual machine is advantageously set up via the basic operating system or the hypervisor in the basic operating system. Therefore, the basic operating system of the physical computer system controls a restriction to the communication of the virtual machine so that the virtual machine can communicate with other virtual machines exclusively on a virtual level, that is to say in particular within at least one set-up virtual communication subnetwork. Connections of the virtual machine to an external physical network are prevented or stopped in this case (as standard). This property is advantageously attained by virtue of the virtual machine having no network port with a connection to an external physical network, or applicable network ports being blocked by the basic operating system. In specific situations (e.g., setting up or configuring the explained method or a specific communication with an authorized external system), however, it is possible to permit selective (temporary) establishment of a connection from the virtual machine to the outside. In an example, the computer system architecture comprises multiple virtual machines, with selective establishment of a connection to the outside being set up for one or more, selected virtual machines (producing a specific functionality, e.g., collection of data from an external service) and being permanently prevented/stopped for other virtual machines.

The network ports of the physical computer system in the computer system architecture are set up such that relaying a communication between the virtual machine and other virtual machines within the virtual communication subnetwork or possibly within multiple virtual communication subnetworks beyond the physical computer system by the external physical network is permitted to the desired extent. Further, however, the network ports of the physical computer system are additionally set up such that establishment of a connection from the external physical network from outside the physical computer system to the physical computer system independently of the virtual communication subnetwork is prevented.

The network ports of the physical computer system are therefore set up such that only relaying a communication within the virtual communication subnetwork(s) is relayable between virtual machines via an external physical network, but other connection attempts by an external system from the external physical network to the physical computer system that are made independently of the virtual communication subnetwork(s) are blocked or rejected. The network ports of the physical computer system thus permit only establishment of a connection via specifically set-up and enabled services that exclusively relay a communication within the virtual communication subnetwork(s). For all other services, the network ports of the physical computer system are advantageously closed. In the latter case, the network ports are thus not passively opened ports (what are known as “listening” ports), that is to say that there are no running services of the physical computer system sitting at these network ports that “eavesdrop” on the external network and would allow establishment of a connection from the outside to the physical computer system. Rather, the network ports are closed or externally unreachable or unaddressable for such services.

However, it is possible that the virtual machine is set up such that establishment of a connection from the external physical network from outside the physical computer system directly to the virtual machine is possible. In this case, the virtual machine can have, e.g., an IP address of its own (independent of the physical computer system). The virtual machine can further provide one or more services (e.g., a web server service) addressable from the external physical network on one or more network ports set up for this purpose. However, establishment of a connection from the virtual machine to the external physical network is (as explained above) nevertheless preferably prevented in general, apart from possible specific situations.

The term “external physical network” comprises network infrastructures of one or more local area networks (LANs) and/or network infrastructures of a publicly available network (World Wide Web, Internet). This means that the network ports of the physical computer system are set up such (see explanations above) that both connection attempts by other physical computer systems from a local area network and from a public network are stopped that are independent of a communication within the virtual communication subnetworks that is relayed via the network infrastructure.

Advantageously, the physical computer system is set up as a server such that this server makes predetermined services available within one or more virtual communication subnetworks by one or more virtual machines (in which particular application programs are set up), but without the physical computer system itself providing services independent of the virtual communication subnetworks to the physical external network externally via the network ports. Such a server can certainly provide complex functions and may be set up, e.g., as a virtualized web, application or database server or as a combination of these. It is possible that, in particular when there are a plurality of virtual machines, single virtual machines are externally addressable from the external physical network, e.g., to address services (e.g., web server services) specifically provided by these virtual machines. Other virtual machines in this case are advantageously not linked to the external physical network in general. These virtual machines can communicate only by the virtual communication subnetwork(s).

The design of a computer system architecture explained above has a synergistic effect compared to conventional solutions. This effect is distinguished first in that complete encapsulation of operating systems and application programs running thereon that are classified as potentially unsafe is effected within a virtual machine, with a data connection neither from the virtual machine to the external physical network nor from the external physical network to the physical computer system (and as a result possibly to the virtual machine) being possible. Therefore, encapsulation both against penetration of the physical computer system from the external physical network and against unwanted establishment of a connection from the virtual machine or from the physical computer system to the external network is produced.

Second, the setup of one or more virtual communication subnetworks between a multiplicity of virtual machines, which are possibly set up on a multiplicity of physical computer systems, is possible and prepared by the depicted computer system architecture so that even larger virtualized networks or IT networks can be set up by interconnection of a plurality of such computer system architectures.

Our computer system architecture therefore combines advantages of conventional individual solutions to produce a novel design with the effect that increased security both against attacks by external harmful systems in the physical computer system or in the virtual machine and against manipulated unwanted data withdrawal from the virtual machine to the external physical network is ensured. Software rated as potentially unsafe can therefore be operated with significantly increased security compared to previous approaches, and complex infrastructures can still be produced.

Our design is based on the considerations that basic operating systems used in computer network infrastructures, and application programs running on the basic operating systems may be unsafe in the sense, explained above, that the basic operating systems and application programs are attackable externally and deliberately or inadvertently forward data externally to an external network, to unwanted third parties, as a result of manipulative errors or other security gaps. Unsafe systems of this kind can be operated within the virtual machine of the computer system architecture of the type explained, with control being effected via the basic operating system of the physical computer system, which is advantageously deemed safe compared to the operating system and application programs to be operated. The basic operating system may be an open source operating system in an internationally developed distribution not subject to particular interests or constraints of individual organizations, for example. Ideally, an audit at source code level is also possible for such a basic operating system to be able to understand the behavior of the basic operating system and its components (e.g., drivers, service programs and system programs) in transparent fashion. It is also possible for the basic operating system to be specifically developed and/or tempered for the task envisaged here and provide only the necessary functionalities, without containing confusing and over extravagant functionalities.

Encapsulation of the systems in the virtual machine of the computer system architecture deemed potentially unsafe obviates the need to have to make extensive security rules and firewall settings for the operating systems and application programs to be operated for the purpose of separation from other systems. This is because the basic operating system stops, as explained above, establishment of a connection from the virtual machine to an external physical network outside the physical computer system, apart from specifically configured connections within one or more virtual communication subnetworks for the purpose of application-specific communication between a plurality of virtual machines that produce a specific functionality of the computer system architecture. Use of virtualization in conjunction with the nonexistence of network interfaces on the virtual machines that would be connected to the physical world therefore attains the advantageous effect that undesirable establishment of a connection from the virtual environment to the external physical network is stopped without requiring extensive continuous security administration for the operating systems to be operated by firewall rules. The computer system architecture is therefore much simpler to handle and at the same time also more robust because there is no longer any susceptibility to error for complicated firewall rules for any operating systems and application programs running thereon.

Simultaneous separation of the physical computer system from the outside such that it is not possible for a connection to be established from the external physical network (as explained above) to the physical computer system, apart from a relayed communication within the virtual communication subnetwork(s) relayed via the external physical network, additionally increases the protection of the computer system architecture significantly. This protection can be attained by selective port closure of the network ports of the physical computer system, for example, which are totally independent of the behavior of the systems to be operated within the virtual environment, however. This also contributes to simplified handling of the computer system architecture. Also, the effect achieved by the protection of the physical computer system against connections from the outside is that a manipulative attack on the physical computer system, let alone on the virtual environment within the physical computer system, is not possible. In this manner, an attacker is unable to gain manipulative access to the physical computer system, or can do so only with very great difficulty to tap off data within the physical computer system or acquire extended control of the virtual environment and the systems running therein. Even if an attacker were to gain access to a physical computer system within a computer network infrastructure, further penetration or a further breach of other physical computer systems within the computer network infrastructure is rendered extremely difficult.

All in all, our computer system architecture therefore combines a wide variety of measures to produce a synergetic security design against improper data use that is easy to handle and still allows flexible setup of a network topology via virtual communication subnetworks so that it is also possible for complex computer network infrastructures to be established.

The virtual environment may further have at least one virtual storage interface, wherein the virtual storage interface is controllable by the basic operating system and set up to provide physical storage components as virtual storage components for the virtual machine. The virtual machine is linked to the virtual storage interface and is set up for communication with the virtual storage components. In this example, physical storage components may be provided as virtual storage components for the virtual machine. That is to say that the virtual machine sees only virtual storage components and can incorporate only these. In this case, the physical storage components are advantageously invisible and unreachable or unaddressable for the virtual machine. The physical storage components may be set up within the physical computer system or else as external storage components. It is, e.g., possible to link physical storage components within a storage subnetwork (e.g., a storage area network, SAN) to the physical computer system. Provision and logical “translation” of the physical storage components as and into the virtual storage components are effected by the virtual storage interface. The latter is controlled by the basic operating system or the hypervisor. However, it is also possible to provide an interface separate from the hypervisor (e.g., in the form of a pseudo device or the like) for this purpose.

The network ports of the physical computer system may be additionally advantageously set up such that a communication with external storage components within a storage subnetwork beyond the physical computer system by the external physical network is permitted. In a possible configuration, the network ports of the physical computer system and the virtual machine are advantageously set up such that exclusively establishment of a connection of the physical computer system to the external storage components within the storage subnetwork is rendered possible, but establishment of a connection from the storage subnetwork neither to the physical computer system nor to the virtual machine is possible. Corresponding connection attempts are blocked, rejected or are simply not possible. Advantageously, establishment of a connection from the external physical network from outside the physical computer system to the physical computer system independently of the storage subnetwork (and, as explained above, of the virtual communication subnetwork) is generally prevented.

The computer system architecture is therefore advantageously set up so that the virtual machine can access virtual storage components to store data. The virtual storage components are translated for physical storage components via the virtual storage interface. These measures are controlled by the basic operating system, preferably via a hypervisor in the basic operating system.

The cited measures also attain protection against manipulative access to the physical computer system or the virtual machine for the purpose of acquiring data that the virtual machine files in applicable (virtual) storage components of a storage system provided for this purpose. Interchange of data between virtual machines and the virtual storage components is effected exclusively under the control of the virtual storage interface. Forwarding of such data to be stored to unauthorized external systems, which differ from the storage components, by the virtual machine is prevented by virtue of the virtual machine, as explained above, being set up such that establishment of a connection to the external physical network, which has a different configuration than the storage subnetwork, is prevented.

The basic operating system and the virtual environment set up such that establishment of a connection from the virtual machine to the basic operating system is prevented, but establishment of a connection from the basic operating system to the virtual machine is permitted. Such measures increase the security of the computer system architecture further. An operating system classified potentially as unsafe, or an application program running on the operating system has no way of making a call to the basic operating system. In this manner, the computer system architecture is protected against manipulation from the inside by errors, security gaps or selective manipulations in the operating systems or application programs operated in the virtual machine. Therefore, a potential piece of harmful software within the virtual machine is unable to manipulate security settings or any other functionality of the basic operating system, for example.

In this example, establishment of a connection from the virtual machine to the basic operating system is advantageously prevented by virtue of specific firewall rules being set up in the basic operating system and/or the console of the virtual machine being configured and blocked as appropriate by the hypervisor of the basic operating system.

The basic operating system may be set up to encrypt data of the virtual machine relayed to outside the physical computer system by the external physical network. This means that any data that are supposed to be sent from the virtual machine to the external physical network outside the physical computer system are still encrypted within the physical computer system by the basic operating system. Encryption is effected exclusively by mechanisms within the basic operating system. This has the advantage that any manipulations, errors or security gaps in the operating systems or application programs within the virtual machine have no influence on or else only access to the encryption of the data. As a result of establishment of a connection from the virtual machine to the basic operating system being prevented according to the measures explained above in a preferred example, it is at least not directly possible to ascertain that the data are actually being encrypted within the virtual machine in the operating system to be operated.

Encrypted sending of the data, in particular the data sent to the external physical network outside the physical computer system via one or more virtual communication subnetworks and/or one or more storage subnetworks of the above type, can be attained by setting up a protected, encrypted connection. This can be attained, by way of example, by virtue of the basic operating system being set up to establish one or more “virtual private network connections” to other physical computer systems in an external physical network or accept applicable connections via the external physical network from other physical computer systems. Within the virtual private networks (VPNs) produced in this way, the data are interchanged exclusively in encrypted form. The network ports of the physical computer system are therefore advantageously set up such that appropriate data interchange via VPN connections set up specifically for this purpose is permitted, e.g., specifically configured VPN services are set up. Other connections from outside the physical computer system to the physical computer system are blocked or rejected, as explained above. This means that the physical computer system is unaddressable for connection calls from the external physical network independently of a data communication within a virtual communication subnetwork and possibly independently of a data communication within a storage subnetwork of the type explained above.

Encryption of data can be effected, e.g., via an encryption layer set up specifically for this purpose or a pseudo device in the basic operating system. In Unix and Linux systems, this can be effected, e.g., via the “device mapper.”

Encryption of the data means that it is not possible to access plain data outside the physical computer system by the external physical network. Such measures also protect the data from improper consequences of security gaps in external network components (e.g., routers, switches and the like). Even if data are forwarded to systems of unauthorized third parties via the external physical network or are tapped off in improper fashion, e.g., by administrators in a storage subnetwork, these receive only encrypted content. Bypassing encryption in the basic operating system by an attack from an external system is, as explained above, massively hampered by the fact that the network ports of the physical computer system, apart from connections within a virtual communication subnetwork or a storage subnetwork, prevent or block any connection attempts from the external physical network. Optionally, security can also be increased further by virtue of a repeated authentication or a repeated encryption being set up.

The text below depicts an advantageous computer network infrastructure using a plurality of computer system architectures of the type explained above. The computer network infrastructure comprises a plurality of such computer system architectures connected via at least one physical network (of the type explained above). In the computer network infrastructure, at least one virtual machine of the respective computer system architectures is connected to at least one virtual machine of at least one other computer system architecture via at least one virtual communication subnetwork. The computer network infrastructure is set up such that a communication within the at least one virtual communication subnetwork is relayed between the physical computer systems by the at least one physical network.

Such a computer network infrastructure comprises the advantages as have been explained in connection with a computer system architecture of the type depicted above. In such a computer network infrastructure, a multiplicity of virtual machines are networked, the virtual machines being distributed over the plurality of physical computer systems of the respective computer system architectures and being able to communicate with one another within one or more virtual communication subnetworks. In this manner, virtual networks having a complex scope of functions can be produced. It is thus possible for such a computer network infrastructure to be used to provide complex server functionalities, e.g., comprising web, application and/or database functionalities.

A great advantage of such a computer network infrastructure in this case is that extensive and complex security rules or firewall rules are dispensed with despite a complex functionality. In such an infrastructure, it is not necessary for globally valid firewall rules to be set for every application in every computer system. Such firewall rules would lead to confusing settings in a large infrastructure. Rather, protection of the infrastructure is provided by virtue of operating systems and applications being encapsulated within the virtual machines of the respective computer system architectures and not needing to be controlled via complex firewall rules. As a result of every virtual machine being prohibited from establishing a connection to the external physical network (see explanations above), sensitive or confidential data are prevented, in such an infrastructure, from leaving the infrastructure via unwanted network connections. In this respect, errors and security gaps in the operating systems and applications within the virtual machines have no or only a very hampered effect.

The respective virtual machines of the respective computer system architectures are controlled via the applicable basic operating systems in the physical computer systems. This control prevents applicable establishment of a connection by the virtual machines to the external physical network. In this manner, very simple and nevertheless effective security control for the computer network infrastructure is ensured. Within the virtual machines, a wide variety of applications and systems may be set up to produce particular application-specific functionalities. Therefore, the computer network infrastructure is nevertheless very flexible in the setup of application-oriented functionalities.

In addition to protection against data manipulation from inside the virtual machines to outside the computer network infrastructure, the computer network infrastructure also affords effective protection against penetration from outside. This is because, as depicted in connection with a single computer system architecture above, all of the network ports of the respective physical computer systems of the computer network infrastructure are set up such that only relaying of a (possibly encrypted) communication within the virtual communication subnetwork(s) between the physical computer systems by the external physical network is permitted but establishment of a connection from the external physical network to the respective physical computer systems independently of the virtual communication subnetwork(s) is prevented.

In other words, such a computer network infrastructure can be used to provide a complex functionality protected or encapsulated against manipulations or attacks both from the inside to the outside and from the outside to the inside, however. Manipulation attempts from the outside are hampered to the extreme and the effects thereof are reduced to a best possible minimum. The physical computer systems of the computer network infrastructure are simply not addressable from the outside via the physical external network. Connections that are independent of communications via the virtual communication subnetwork(s) are ignored completely. On the other hand, the computer network infrastructure is protected against data withdrawal as a result of errors or security gaps in operating systems or application programs that run within the virtual machines of the respective computer system architectures. On account of the virtualization, a security barrier is provided that prohibits a system or an application within a virtual machine from actually being able to establish an (unwanted) connection to the outside. Any communication by the systems involved is enclosed within the virtual communication subnetwork(s). Such a computer network infrastructure is easy to administrate from a security point of view and still allows a significantly higher degree of security in comparison with conventionally designed infrastructures.

errors and security gaps can be exploited by attackers from an external n components for storing data of the virtual machines of the computer system architectures. The storage components are addressable as virtual storage components by at least some of the virtual machines. In one example, the storage components outside the physical computer systems are set up as physical storage components (e.g., within what is known as a storage area network, SAN) and addressable via one or more storage subnetworks. The computer network infrastructure in this example is set up such that a communication within the storage subnetworks outside the physical computer systems is relayed by the at least one physical network. As already described above in regard to a single computer system architecture such an example of a computer network infrastructure also incorporates storage of data that come from the virtual machines and are supposed to be stored. These may be application-specific data, user data, system data or the like, for example.

Linking the virtual machines via one or more storage subnetworks to the storage components that are visible and addressable by the virtual machines only as virtual storage components produces data storage within the depicted security design of the computer network infrastructure in a simple manner. All of the data are interchanged between the subcomponents of the infrastructure exclusively in encapsulated form within the storage subnetwork(s). As already explained above in regard to a single computer system architecture, data outside a physical computer system are advantageously transmitted only in encrypted fashion. Applicable encryption of data from the virtual machines takes place at the level of the basic operating system of a respective physical computer system.

Encryption is advantageously set up such that virtual machines involved have no kind of access to the encryption. Advantageously, encryption is set up independently of the virtual machines such that operating systems and applications within the virtual machines do not even have information available that encryption outside the virtual machines takes place at the basic operating system level. To store data, the virtual machines can address the virtual storage components, this communication being relayed to the actually present physical storage components by the at least one physical network on a technical basis at the level of the basic operating systems, e.g., by a hypervisor or an interface (e.g., of a pseudo device) set up for this purpose. This relaying is set up such that all of the data are encrypted via the basic operating system before they leave the physical computer system. In this manner, the data within the physical network, i.e., also within a physical storage network, are available exclusively in encrypted form. Such measures are also independent of any additional security devices within the storage components or within a physical storage network. In this respect, the computer network infrastructure is also very robust against any manipulations of security devices of the physical storage components. Even in the event of manipulation of storage components, for example, as a result of an external attacker penetrating an appropriately set-up storage area network, the data are already encrypted by the basic operating system of the respective physical computer systems, which means that an attack on the storage components in this regard remains unsuccessful from a security point of view.

Advantageously, the entire computer network infrastructure is set up such that a communication within the at least one virtual communication subnetwork (and also possibly within the at least one storage subnetwork) is relayed between the physical computer systems via one or more virtual private networks (VPNs). This results in the advantages already depicted above in connection with an applicable VPN connection.

In an example of the computer network infrastructure, at least a first and a second virtual private network for relaying the at least one virtual communication subnetwork (and possibly for relaying the at least one storage subnetwork) are set up between two respective physical computer systems. In this case, an addressable VPN service of the first virtual private network is set up on one physical computer system and an addressable VPN service of the second virtual private network is set up on the other physical computer system. This means that with such a configuration between two respective physical computer systems, at least one respective VPN service that provides a connection option via a virtual private network is set up on both computer systems. In this manner, at least two VPNs are usable between two respective physical computer systems. If a VPN service on one of the computer systems fails, it is still possible for a VPN connection to be established between the computer systems involved via the VPN service of the other computer system. In this manner, the computer network infrastructure is particularly failsafe in respect of VPN connections set up between the physical computer systems.

It is also possible to provide more than two possible VPN connections between two respective physical computer systems by virtue of more than two VPN services being set up on the applicable physical computer systems. This increases the failsafety and allows a high availability of the VPN connections between the physical computer systems involved. All of the VPN connections set up between two respective physical computer systems can be combined by what is known as VPN bonding or VPN teaming to produce a redundant connection. This also has the advantage that the entire bandwidth of the aggregated single connections can be increased. In the event of failure of one connection, the one or more remaining connections continue, as explained, to exist as redundant connections.

In an example, multiple separate virtual communication subnetworks are set up in the computer network infrastructure, separate security rules for the virtual machines involved being prescribed for each virtual communication subnetwork. Each separate virtual communication subnetwork can have an IP address space of its own with predetermined private IP addresses of the virtual machines involved. In this manner, multiple separate subnetworks are set up within the computer network infrastructure, with the virtual machines communicating within the subnetworks. Within each communication subnetwork, the communication can be defined on an application-specific basis by security rules, e.g., firewall rules. The security rules are controlled, e.g., via the basic operating system. The advantage of the plurality of separate communication subnetworks is that security rules can be defined for each communication subnetwork independently of the other communication subnetworks. In particular, security rules can be combined with the definition and production of the virtual components (virtual machines, bridges, interfaces and the like) and thus automatically jointly installed, moved or removed. In this manner, management of all the communication subnetworks is very easy to handle from a security point of view. Nevertheless, various security rules finely tuned to a respective application can be set within the individual communication subnetworks. Therefore, the computer network infrastructure allows a networked structure with easy-to-handle security settings that, however, are very finely tunable to the applicable application-specific functionalities. A global security entity (global firewall system) is not necessary that has to provide specific firewall rules for every application in every virtual machine for the purpose of controlling a connection to the outside. An option to connect to the external physical network is prohibited by the virtualization in general, as explained repeatedly above.

The computer network infrastructure may further comprise, besides the components explained, an administration computer system and a broker computer system connected to the at least one physical network for administration of one or more computer system architectures. The network ports of the administration computer system are closed toward the at least one physical network so that establishment of a connection from the at least one physical network from outside the administration computer system to the administration computer system is prevented. However, the broker computer system has at least one open network port toward the at least one physical network and is set up such that both the administration computer system and the physical computer systems of the computer system architectures to be administrated can access the broker computer system via the at least one physical network.

The systems additionally provided here, namely the administration computer system and the broker computer system, are used for administration of one or more, advantageously all, computer system architectures within the computer network infrastructure. These two systems are specifically matched to the security concept of the computer network infrastructure. As already explained repeatedly, the network ports of the physical computer systems of the applicable computer system architectures are set up such that establishment of a connection from the physical network from outside the physical computer systems independently of the virtual communication subnetwork and possibly independently of the storage subnetwork is prevented. This means that no computer system differing from a virtual machine and wanting to communicate with the physical computer systems outside the one or more virtual communication subnetworks is able to establish establishment of a connection to the physical computer systems. Rather, such establishment of a connection is blocked or rejected. On the other hand, however, administrative access to the computer system architectures of the computer network infrastructure is also supposed to continue to be ensured, and such administrative access is often required.

For controlled administrative access of this kind, the administration computer system and the broker computer system are provided. The network ports of the administration computer system are closed, analogously to the network ports of the physical computer systems of the computer system architectures within the computer network infrastructure such that establishment of a connection from the physical network to the administration computer system is prevented. By contrast, the broker computer system has at least one open network port via which establishment of a connection from the physical network to the broker computer system is set up. In contrast to the administration computer system and the physical computer systems of the computer system architectures, the broker computer system is therefore an “open” computer system. This means that both the administration computer system and the physical computer systems of the applicable computer system architectures can access the broker computer system and can retrieve data or data packets from the broker computer system via an appropriately established connection. Applicable data or data packets can therefore be used for a process of interchanging control data for administrative control of the computer system architectures by the administration computer system without the administration computer system itself or the physical computer systems of the computer system architectures having running services on one or more network ports (what are known as listening ports) that present a risk of or susceptibility to attacks via the external network.

In particular, it is possible for the administration computer system to be used to transfer particular control data or data packets for the control, administration or configuration of one or more computer system architectures (that is to say of the physical computer systems and/or of the virtual machines within the physical computer systems) to the broker computer system via a connection established to the broker computer system and file the control data or data packets on the broker computer system. It is then possible for a process to be started in which one or more physical computer systems of the computer system architectures establish a connection to the broker computer system and collect the applicable control data or data packets from the broker computer system and transfer them to itself/themselves. In the physical computer systems or in the virtual machines on the physical computer systems (sometimes by the basic operating system or the hypervisor), it is then possible for particular tasks to be performed on the basis of the transmitted control data or data packets. In this manner, administrative indirect access to the applicable computer system architectures is possible.

Further advantageous examples and further aspects are disclosed in the description of the figures that follows. Our architecture and infrastructure are explained in more detail below with reference to multiple figures on the basis of various examples.

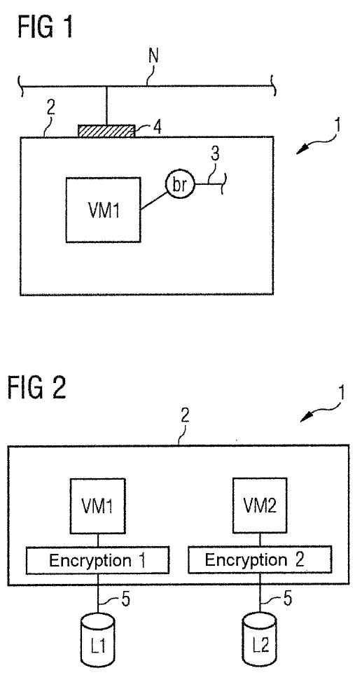

FIG. 1 shows a schematic depiction of a computer network infrastructure 1 comprising a physical computer system 2 and a virtual machine VM1 installed on the physical computer system 2. The physical computer system 2 has a virtual environment, for example, which is controllable via a basic operating system on the physical computer system 2. It is possible, by way of example, to provide in the basic operating system a hypervisor that manages the virtual machine VM1 and allows relaying of a communication between the virtual environment and a physical infrastructure. Current implementations are possible in this case.

The virtual machine VM1 comprises an operating system to be operated and possibly an application program running thereon, for example. The application program can provide an application-specific functionality. It is naturally also possible to set up a plurality of operating systems in parallel within the virtual machine VM1 and have a multiplicity of application programs run.

The physical computer system 2 has one or more network ports 4 connected to an external physical network N in a fashion depicted in a schematic manner. The physical network N is therefore set up outside the physical computer system 2 and comprises a local area network of a computer network infrastructure. Further, the network N can also extend to the public world wide web (Internet). The network ports 4 of the physical computer system 2 are set up such that establishment of a connection from the physical computer system 2 to the external physical network N is possible, but establishment of a connection from the external physical network N to the physical computer system 2 is not possible. Appropriate establishment of a connection to the physical computer system 2 is prevented or blocked, or connection attempts are rejected, by closed network ports 4 (e.g., by a firewall and/or a packet filter), for example. Additionally, the physical computer system 2 optionally has no running services at the network ports 4 that outwardly listen to external connection attempts. Such “listening network ports” are consciously not set up in physical computer systems 2. Therefore, the physical computer system 2 generally behaves as a closed system toward external connection requests from the external physical network N. By way of example, it is not possible for an administrator to use a remote computer system to register by the network N a service in the physical computer system 2 by specific network ports 4 opened for that purpose. However, the physical computer system 2 nevertheless provides relaying of a communication of the virtual machine VM1 to other virtual machines outside the physical computer system 2 by the network N, as explained later.

Besides the virtual machine VM1, the computer system architecture 1 shown in FIG. 1 also comprises what is known as a virtual bridge br of a virtual communication subnetwork 3. The virtual bridge br is depicted in schematic fashion as a functionality and may be provided within the virtual environment via the basic operating system, for example. Advantageously, the virtual bridge br operates as a virtual network connection (interface) to link the virtual machine VM1 to the virtual communication subnetwork 3. The virtual bridge br may be set up within a protocol stack based on what is known as the OSI layer model as a virtual hardware bridge having a functionality according to layer 2 (data link layer), for example.

In this manner, the virtual machine VM1 is set up to the communication subnetwork 3 for communication with other virtual machines. Otherwise, the virtual machine VM1 is controlled by a basic operating system, or the applicable hypervisor, set up on the physical computer system 2 such that establishment of a connection from the virtual machine VM1 to the external physical network N is prevented. This means that the virtual machine VM1 has no external interface to link to the external physical network N. Therefore, the virtual machine VM1 can perform communication (i.e., connection calls or relaying assumptions) only via the virtual bridge br within the communication subnetwork 3.

Additionally, the virtual machine VM1 is set up and controlled by the basic operating system and/or the hypervisor such that a call by the virtual machine VM1 to the basic operating system of the physical computer system 2 is not permitted or not possible or stopped. This is implemented by suitable firewall rules in the basic operating system, for example. Alternatively or additionally, it is possible for, e.g., the hypervisor of the basic operating system in the physical computer system 2 to control a console or another control device of the virtual machine VM1 such that a call to the basic operating system is not possible from the console or the control device of the virtual machine VM1.

On the basis of the cited security mechanisms, the computer system architecture 1 shown in FIG. 1 is therefore a totally encapsulated structure. An operating system running in the virtual machine VM1, or an application program running on the operating system, which operating system and application program can generally have errors and/or security gaps and are therefore deemed potentially unsafe, cannot establish a data connection to the outside of the physical computer system 2 via the network N, because such a functionality is prevented by the basic operating system running on the physical computer system 2 (which basic operating system is ideally deemed safe compared to the operating system to be operated within the virtual machine VM1) or by the hypervisor. In this respect, the virtualization within the computer system architecture 1 is a safety barrier against errors or security gaps in a program running within the virtual machine VM1.

To be able to realize an application-specific and also complex computer network infrastructure, however, the virtual machine VM1 is linked to the communication subnetwork 3 via the virtual network bridge br and can communicate with other virtual machines to realize and provide an appropriate functionality. In specific instances of application, the virtual machine VM1 can (temporarily) establish a connection to an external system via the communication subnetwork 3 (conveyed via the physical network N). This is a special case, however. Further, it is possible for an external system to use the communication subnetwork 3 (conveying via the physical network N) to directly establish a connection to the virtual machine VM1. A connection to the physical computer system 2 from the outside is prevented (as explained above) by the appropriately configured network ports 4, however.

Additionally, the physical computer system 2 is protected against illegal connection calls to the physical computer system 2 via the network N on the basis of the outwardly closed network ports 4. As a result, the physical computer system 2 is correspondingly robust against attacks from the network N because, as explained, there are no running services set up on the network ports 4 on the physical computer system 2 that would provide a conventional opportunity for attack.

FIG. 2 shows an example of a computer system architecture 1, wherein a further functionality is illustrated. The computer system architecture 1 as shown in FIG. 2 may, in principle, be designed in accordance with the explanations for a computer system architecture 1 as shown in FIG. 1. In a slight modification as shown in FIG. 2, the computer system architecture 1 has two virtual machines VM1 and VM2, however, set up in an applicable virtual environment on the physical computer system 2 and are controllable via a basic operating system or a hypervisor.

FIG. 2 illustrates a mechanism that stores data that are supposed to be filed from the virtual machines VM1 and VM2 on storage components. To store data from the virtual machines VM1 and VM2, the virtual machines can access virtual storage components linked via a storage subnetwork 5 as physical storage components L1 and L2. The storage subnetwork 5 is actuated via the basic operating system or the hypervisor. The virtual machines VM1 and VM2 can merely address virtual storage components (not depicted) visible to them. The virtual storage components may be matched to particular functionalities or applications within the virtual machines VM1 or VM2, for example. A logical translation from the virtual storage components visible to the virtual machines VM1 and VM2 to the physical storage components L1 and L2 is effected via the basic operating system, more precisely via the hypervisor thereof or a specifically set-up interface, e.g., a pseudo device. The latter can be created, e.g., in a Linux system using the device mapper.

To store data, the virtual machines VM1 and VM2 address the virtual storage components and can then transfer data to the virtual storage components and file (store) them therein. At the level of the basic operating system of the physical computer system 2, the virtual storage components are translated into the physical storage components L1 and L2. Further, the basic operating system establishes an appropriate connection via the storage subnetwork 5 to the storage components L1 and L2 and can then send the data to be stored to the storage components L1 and L2 so that the data are filed therein. At the physical level, such data storage is relayed via the basic operating system of the physical computer system 2 to outside the physical computer system 2, e.g., by the network N depicted in FIG. 1 or by a specifically set-up physical storage network. This is because in the example shown in FIG. 2, the storage components L1 and L2 are set up in the form of physical storage components outside the physical computer system 2. By way of example, the storage components L1 and L2 are part of a storage system, e.g., of what is known as a storage area network (SAN). The storage components are addressable, e.g., as a disk array via LUN addressing (LUN=Logical Unit Number) in a storage area network. The storage components L1 and L2 may be, e.g., redundant hard disk stores, distributed data stores and the like. As an alternative to the example depicted in FIG. 2, the storage components L1 and L2 may also be set up as physical storage components within the physical computer system 2. In this case, relaying via the basic operating system is effected only within the physical computer system 2.

As shown in FIG. 2, encryption of the data from the virtual machines VM1 and VM2 is effected in each case at the level of the basic operating system classified as safe. This process is depicted by “Encryption1” and “Encryption2” in FIG. 2. Encryption can be effected, e.g., by an encryption layer specifically set up for this purpose, or a specifically set-up interface, e.g., a pseudo device (see above). An operating system to be operated, with its application programs in the virtual machines VM1 and VM2, has no influence on and no access to this encryption. Ideally, the virtual machines VM1 and VM2 are set up or controlled via the basic operating system such that the virtual machines VM1 and VM2 are provided with no information at all about any encryption actually taking place at the level of the basic operating system. In this manner, data from the virtual machines VM1 and VM2 are communicated via the physical network N (or a dedicated storage network) to outside the physical computer system 2 only in encrypted form. The data can additionally be encrypted further in the physical storage components and in the storage subnetwork 5. Access to unencrypted data from the virtual machines VM1 and VM2 is not possible outside the physical computer system 2, however.

On account of the fact that establishment of a connection from the physical network N to the physical computer system 2 by the network ports 4 is not permitted, an attack on plain data (before encryption) present within the physical computer system 2 can also be achieved only with very great difficulty. In this respect, the probability of a successful attack on information within the physical computer system 2 is severely reduced. Additionally, communication of data from the virtual machines VM1 and VM2 via the basic operating system or the hypervisor thereof is controlled in such specific fashion that communication is permitted only within a storage subnetwork 5 and within a communication subnetwork 3 (cf. FIG. 1). Therefore, an operating system or an application program running within a virtual machine VM1 or VM2 is prevented from unwanted establishment of a connection to the external physical network N. In this manner, successful exploitation of a backdoor or other security gaps in an operating system to be operated or an application program to be operated within the virtual machines VM1 or VM2 is additionally also extremely unlikely.

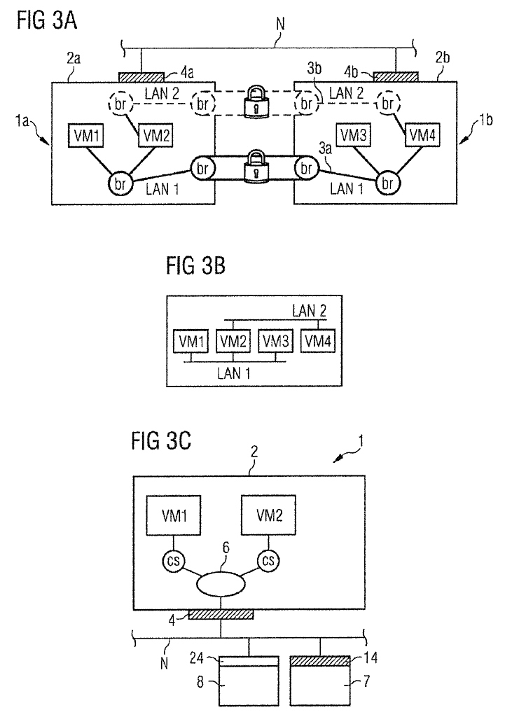

FIG. 3A shows a schematized depiction of a computer network infrastructure comprising two computer system architectures 1a and 1b each comprising a physical computer system 2a and 2b. Within a virtual environment of the physical computer system 2a, two virtual machines VM1 and VM2 run. Within a virtual environment of the physical computer system 2b, two virtual machines VM3 and VM4 run. The physical computer systems 2a and 2b are connected via a physical external network N by applicable network ports 4a and 4b. The physical computer systems 2a and 2b are in particular set up in accordance with the explanations pertaining to FIGS. 1 and 2.

The virtual machines VM1, VM2, VM3 and VM4 are linked to two communication subnetworks 3a and 3b in the respective virtual environments of the physical computer systems 2a and 2b via various virtual network bridges br. In particular, as shown in FIG. 3A, the virtual machines VM1, VM2 and VM3 are connected via virtual network bridges br within a communication subnetwork 3a (LAN1), while the virtual machines VM2 and VM4 are connected via virtual network bridges br within a further communication subnetwork 3b (LAN2). FIG. 3b depicts such a topology in simplified fashion as an equivalent circuit diagram.

The virtual machines VM1 and VM2 communicate via the virtual communication subnetwork 3a merely within the physical computer system 2a, apart from any use of protocols such as broadcast, multicast or protocols with similar behavior. A communication from VM1 or VM2 to VM3 and vice versa or between VM2 and VM4 and vice versa takes place across the boundaries of the physical computer systems 2a and 2b. In this respect, a communication is relayed between the virtual machines by the external physical network N. In this regard, one or more encrypted connections, for example, VPN connections below are set up between the physical computer systems 2a and 2b (see lock symbols of the connections, depicted in schematic fashion, of the communication subnetworks 3a and 3b between the physical computer systems 2a and 2b). The VPN connections are used to transmit data between the physical computer systems 2a and 2b in encrypted form via the network N and relay a communication between the virtual machines. To be more precise, a communication between the virtual machines within the virtual communication subnetworks 3a and 3b is converted by the basic operating systems or the hypervisors thereof on the physical computer systems 2a and 2b into a physical transport within the VPN connections along the network N. In this manner, the virtual machines VM1 to VM4 can communicate with one another within appropriately set-up communication subnetworks 3a and 3b.

To relay an applicable communication via the network N, the network ports 4a and 4b of the physical computer systems 2a and 2b are set up as appropriate. Specifically, the network ports 4a and 4b are blocked as appropriate for connection requests from the network N from outside the physical computer systems 2a and 2b (as explained above). However, this applies to connection requests independent of a communication by the virtual communication subnetworks 3a and 3b. This means that the network ports 4a and 4b still permit specifically set-up VPN connections between the physical computer systems 2a and 2b. To this end, appropriate VPN services are set up in the physical computer systems 2a and 2b so that establishment of a connection is possible via VPN connections between the physical computer systems 2a and 2b. Other connection attempts from outside the physical computer systems 2a and 2b via the network N are ignored, blocked or rejected at the network ports 4a and 4b, however. An implementation is advantageously effected using applicable firewall rules or other configurations with a comparable result within the physical computer systems 2a and 2b.

In this manner, a computer network infrastructure is set up between the physical computer systems 2a and 2b, with virtual machines VM1 to VM4 being able to communicate via two virtual communication subnetworks 3a and 3b (cf. the labels LAN1 and LAN2 in FIG. 3B). All of the virtual machines VM1 to VM4 are encapsulated for security purposes in accordance with the explanations pertaining to FIGS. 1 and 2. At the same time, the physical computer systems 2a and 2b are protected against attacks from the physical external network N on the network ports 4a and 4b according to the explanations above. Such a topology of a computer network infrastructure allows a complex network topology of producing application-specific functionalities. In this manner, virtualized server structures and complex services can be mapped via the virtual machines VM1 to VM4, with communication taking place via bridged communication subnetworks 3a and 3b.

A critical aspect is that establishment of a connection from the individual virtual machines VM1 to VM4 directly to the physical external network N is stopped or just not “set up” or “wired up” in the first place. In this respect, the virtual machines VM1 to VM4 cannot make a connection to a public IP address space. The virtual machines VM1 to VM4 have no interface to the external physical network N for this purpose. The virtual machines VM1 to VM4 merely see one another as applicable computer components within the virtual communication subnetworks 3a and 3b and can address and contact one another. Applicable relaying of a communication is effected, as explained, via VPN connections of the physical computer systems 2a and 2b along the network N. The VPN connections are controlled via the respective basic operating systems or the hypervisors thereof. An effect of an error or a security gap in a system within one or more virtual machines VM1 to VM4 is restricted merely to the virtual communication subnetworks 3a and 3b and to a certain extent enclosed within the communication subnetworks 3a and 3b. In this respect, the virtual machines VM1 to VM4 are unable to transmit data in a readable form via unwanted network connections to an unauthorized third-party computer system via the network N. Also, applicably configured network ports 4a and 4b of the physical computer systems 2a and 2b render an attack on the physical computer systems 2a and 2b from the network N extremely difficult.

FIG. 3C shows a schematic depiction of components of a computer network infrastructure to illustrate a further functionality. The computer network infrastructure shown in FIG. 3C shows a computer system architecture 1 comprising a physical computer system 2 and two virtual machines VM1 and VM2. Network ports 4 connect the physical computer system 2 to an external physical network N. Further, an administration computer system 7 and a broker computer system 8 are connected to the network N. Both the network ports 4 of the physical computer system 2 and the network ports 14 of the administration computer system 7 are set up such that establishment of a connection from the network N to the physical computer system 2 or the administration computer system 7 is prevented. It is therefore not readily possible to gain administrative access to the virtual machines VM1 and VM2 within the physical computer system 2 via an external computer system (not depicted) by the network N and the network ports 4. Conversely, the virtual machines VM1 and VM2, as explained above, do not have an interface to the physical network N. A connection call from the virtual machines VM1 and VM2 via the consoles cs thereof to the basic operating system of the physical computer system 2 is also stopped by firewall rules of the basic operating system or a control of the consoles cs by a hypervisor of the basic operating system. So that administrative access or control of the virtual environment, in particular of the virtual machines VM1 and VM2, within the physical computer system 2 is ensured, however, the following process can be performed.

The administration computer system 7 can be used to establish a connection to the broker computer system 8. To this end, the broker computer system 8, in contrast to the administration computer system 7 or the physical computer system 2, has at least one addressable, open network port 24. In this manner, the administration computer system 7 can establish a connection to the broker computer system 8 and file one or more data packets with control data in the broker computer system 8. The physical computer system 2 can then establish a connection to the broker computer system 8 via the network N to transmit the data packets of the administration computer system that are filed in the broker computer system to itself. In this manner, control data can be transferred to the physical computer system 2 without a connection being actively established from the outside to the physical computer system 2 via the network N, which would conventionally be a typical opportunity for attack from the outside.

The data packets applicably transferred to the physical computer system 2 can be processed further in the basic operating system of the physical computer system 2. By way of example, a particular task can be performed so that the basic operating system carries out controlled access to the virtual environment, more precisely to the virtual machines VM1 operating state VM2, on the basis of the transmitted data packets. This is performable by a specific entity 6 of the basic operating system. By way of example, the entity 6 of the basic operating system establishes a connection to the console cs or another interface of a virtual machine VM1 and VM2 that is used for this purpose, applicable control of the virtual machines VM1 and VM2 being able to be performed via control data. However, it is also possible for the console cs of a virtual machine VM1 and VM2 to be used to load applicable control data, scripts or programs into the virtual machine VM1 or VM2 so that an operating system running in the virtual machine VM1 or VM2 can execute the applicable control data, scripts or programs so that remote control of the virtual machines VM1 and VM2 is more or less achieved. In this manner, secure administrative access indirectly from the administration computer system 7 via the broker computer system 8 to the physical computer system 2 or the virtual environment of the physical computer system 2 is made possible. All of the processes can be protected via applicable signatures within the administration computer system 7, the broker computer system 8 and the physical computer system 2. Advantageously, a communication via the network N is effected exclusively in encrypted form.

It is alternatively or additionally also possible to use an applicable script or applicable control data to enable access to the virtual machines VM1 or VM2 by the basic operating system. In this case, the basic operating system can effect controlling access to the virtual machines VM1 and VM2 such that port forwarding or a tunnel in the basic operating system to the desired virtual machine VM1 or VM2 is enabled, for example. This is a highly specific individual case from a security point of view, with a virtual machine VM1 or VM2 making a selectively opened network port outwardly available to the network N so that selective access to the virtual machine VM1 or VM2 is made possible. This should be protected by specific security mechanisms, however, such as, e.g., temporary enabling, verification of applicable security scripts or applicable authentication packets, verification of concordance of authentication mechanisms, source ports, destination ports and the like. Similarly, it is possible in this context to provide a many-eyes principle for security personnel.

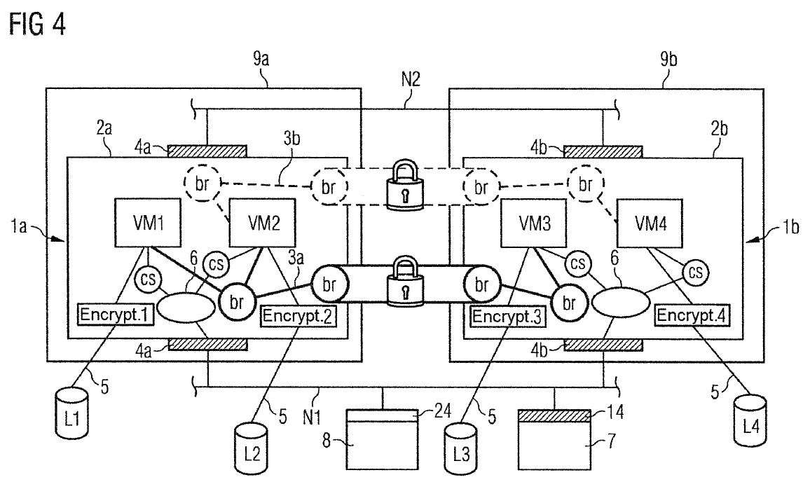

FIG. 4 shows a schematic depiction of a combined overview of the functionalities depicted as shown in FIGS. 1 to 3C within a computer network infrastructure established using multiple computer system architectures 1a and 1b. A communication is relayed between the individual computer systems via the physical networks N1 and N2 according to the configuration in FIG. 4. These may be separate networks, but also alternatively parts of an overall network or may be an overall network per se.

FIG. 4 clarifies the complexity of an implementation of an applicable computer network infrastructure. A substantial advantage of such an infrastructure in comparison with conventional solutions is, as repeatedly explained above, that encapsulation of possible harmful programs within the virtual environments of the physical computer systems 2a and 2b is achieved on the basis of a virtualization of operating systems or application programs within virtual machines VM1 to VM4. The virtual machines VM1 to VM4 cannot establish a connection to the external networks N1 and N2. At the same time, the physical computer systems 2a and 2b are protected against an attack from the networks N1 and N2 by their network ports 4a and 4b.

The operating systems or application programs running within the virtual machines VM1 to VM4 do not, in this manner, have to be outwardly protected from the physical networks N1 and N2 via specific firewall rules. An applicable security blockade is obtained purely by the virtualization within the physical computer systems 2a and 2b. Such virtualization means that there is no provision for establishment of a connection from the virtual machines VM1 to VM4 to the physical network N1 or N2. Therefore, adaptation and administration of a complex firewall architecture for N application programs on m physical computer systems within an applicable computer network infrastructure are dispensed with. Security-oriented encapsulation of the operating systems running in the virtual machines from the outside, in combination with separation of the physical computer systems from the external physical networks N1 and N2 against an attack from the networks N1 and N2, achieve a particularly high level of security for the computer network infrastructure. Nevertheless, simple administration of an applicable computer network infrastructure is made possible. Also, complete application-specific functionalities can be implemented via the virtual machines and the communication options thereof via bridged communication subnetworks 3a and 3b (see FIG. 4, for example).

As shown in FIG. 4, the physical computer systems 2a and 2b are also additionally protected against physical manipulations in high-security racks 9a and 9b. This also results in further security advantages.

Communication between the physical computer systems 2a and 2b for the purpose of relaying a communication between the virtual machines VM1 to VM4 takes place exclusively via encrypted VPN connections, as explained above. Data from the virtual machines VM1 to VM4 can be stored in virtual addressable storage components L1 to L4 via applicable storage subnetworks 5. Administration of the applicable computer system architectures 1a and 1b is effected via an administration computer system 7 using a broker computer system 8 in accordance with the explanations pertaining to FIG. 3C.

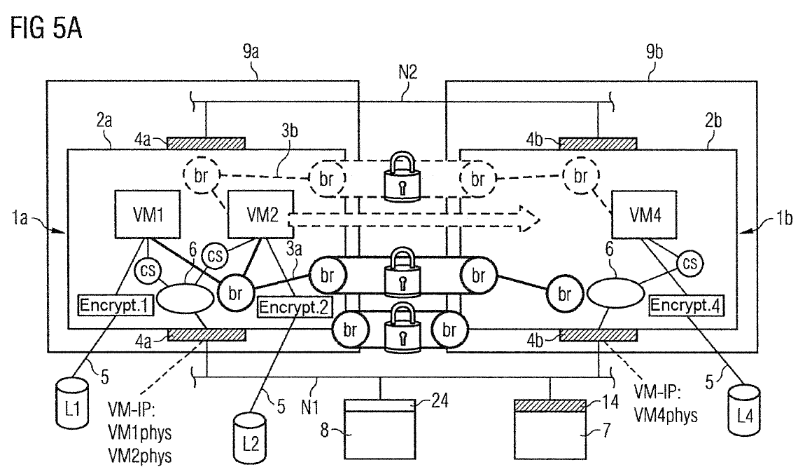

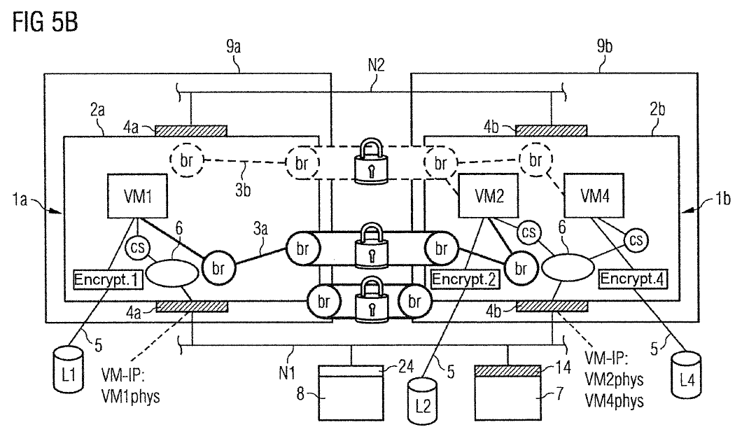

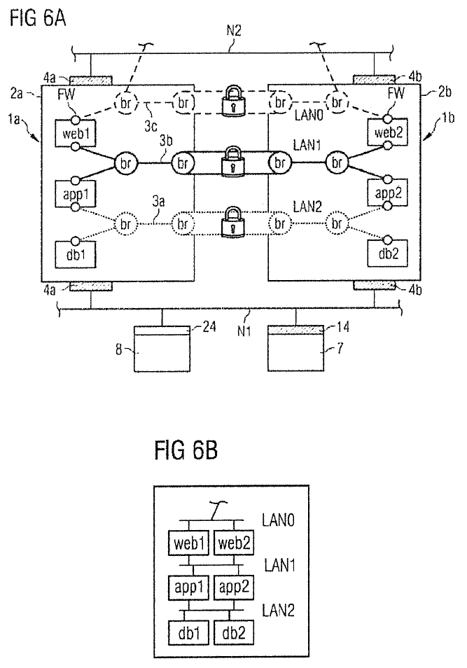

FIG. 5A shows a computer network infrastructure of analogous design to the one from FIG. 4, with the difference that only three virtual machines are used in the computer network infrastructure shown in FIG. 5A. Two virtual machines VM1 and VM2 are set up on the physical computer system 2a, with one virtual machine VM4 being set up on the physical computer system 2b. FIG. 5A shows a first configuration of the computer network infrastructure.

By way of example, the virtual machine VM2 on the physical computer system 2a now needs to be moved to the physical computer system 2b. A move can be controlled in this case via the measures of administrative access to the virtual machines, e.g., by the administration computer system 7 and a broker computer system 8, as explained above in particular in regard to FIG. 3C. To move the virtual machine VM2, the operating system running in the VM2 can be powered down or a live migration of the VM2 can be performed. All the necessary steps can be controlled via control data, which can be initiated by the administration computer system 7 and transported to the physical computer system 2a or the physical computer system 2b (or to the basic operating systems thereof) and finally to the virtual machine VM2 by the broker computer system 8 and processed at an applicable point, i.e., in the basic operating system of the physical computer system 2a and/or in the basic operating system of the physical computer system 2b and in the virtual machine VM2. Such control data are used inter alia to establish encryption at the level of the basic operating system in the physical computer system 2b to be able to link the virtual machine VM2 to storage components again via an applicable storage subnetwork 5 after the move to the physical computer system 2b.

Moving the virtual machine VM2 further requires a link to an applicable communication subnetwork 3a or 3b to be set up on the physical computer system 2b. This requires in particular a virtual network bridge br to link the virtual machine VM2 after the move of the virtual machine to the virtual environment of the physical computer system 2b. The communication subnetwork(s) 3a or 3b to which the virtual machine VM2 is intended to be linked on the physical computer system 2b can either be assigned dynamically (on demand) or already be statically preconfigured in the virtual environment on the physical computer system 2b. Applicable relaying of a communication from the virtual environment of the physical computer system 2b to a physical external network (cf. N1 and N2) via the basic operating system likewise needs to be adapted as appropriate via the basic operating system of the physical computer system 2b.

A move via a live migration requires an advantageously encrypted network connection between the two basic operating systems involved on the physical computer systems 2a and 2b for transmission of the data. The data transfer for a live migration can either be realized via existing encrypted connections (e.g., VPN connections between the physical computer systems 2a and 2b involved) or alternatively be effected within exclusive connections set up specifically for this purpose. A connection set up specifically for a live migration is portrayed in FIG. 5A as an additional bridged network connection between the two physical computer systems 2a and 2b (cf. the schematic depiction of the bottom-most encrypted connection between the two systems). Network ports 4a and 4b can be enabled temporarily for a specifically set-up connection for live migration.

Further, any storage components required need to be made available on the physical computer system 2b via the basic operating system and linked to the virtual environment, in particular to the virtual machine VM2, via an applicable encryption in the basic operating system.

The virtual machine VM2 is addressed before the move by applicable control data or data packets containing a controlled call from the basic operating system to the virtual machine VM2. The data packets are transferred from the administration computer system 7 to the broker computer system 8. Subsequently, a connection is established from the physical computer system 2a to the broker computer system 8 so that the data packets can be transferred to the physical computer system 2a. The basic operating system can be used to process the routing information in the data packets and address the virtual machine VM2 via the console interface cs thereof.

As denoted in FIG. 5A, the virtual machines can be addressed via IP addresses (VM-IP). The virtual machine VM1 has the allocated IP address VM1phys. The same applies to the virtual machines VM2 and VM4 that have the allocated IP addresses VM2phys and VM4phys. In this manner, it is possible for a communication to be set up to the virtual machines.

As shown in FIG. 5A, the virtual machine VM2 can be transferred from the physical computer system 2a to the virtual environment on the physical computer system 2b via a connection specifically set up for this purpose (cf. FIG. 5A) after all of the necessary components have been established and provided in accordance with the explanations above. This is accomplished in the topology shown in FIG. 5A by live migration.

Finally, FIG. 5B shows the applicable configuration of the computer network infrastructure after the virtual machine VM2 is moved to the physical computer system 2b. The virtual machine VM2 is linked both to the communication subnetwork 3a and to the communication subnetwork 3b via multiple virtual network bridges br. The basic operating system sets up encryption of data from the virtual machine VM2 to the storage subnetwork 5 on storage components L2. Additionally, encryption of other data from the virtual machine VM2 is advantageously also realized by the basic operating system of the physical computer system 2b, the data being interchanged with other virtual machines within the virtual communication subnetworks 3a and 3b and being relayed at the physical level via the external network N1 or N2. Such encryption of data can be effected via the basic operating system of the physical computer system 2b by VPN connections to other physical computer systems (the physical computer system 2a in FIG. 5B).

The virtual machine VM2 is addressed after the move to the physical computer system 2b likewise via data packets containing routing information. Such data packets can, as explained above, be transmitted to the physical computer system 2b via the administration computer system 7 by the broker computer system 8, the basic operating system being able to address the virtual machine VM2 via applicable routing information.

So that the virtual machine VM2 is also contactable on the physical computer system 2b by a routing from the administration computer system 7, the routing from the administration computer system 7 needs to be changed according to one option, that is to say that the original destination IP address (host IP) of the interface of the physical computer system 2a needs to be changed to the destination IP address (host IP) of the interface of the physical computer system 2b or the original IP address (VM2phys) of the virtual machine VM2 in the physical computer system 2a needs to be replaced by an IP address (VM2phys) of the virtual machine VM2 in the physical computer system 2b if the network identity (VM2phys) of the virtual machine VM2 in the new virtual environment on the physical computer system 2b has changed.

Another, more convenient option is to set up addressability of the physical computer systems 2a and 2b or of the virtual machine VM2 via what is known as IP aliasing. In a routing, it is then possible for one or more alias IP addresses to be used that are concomitantly transferred from the physical computer system 2a to the physical computer system 2b during the move of the virtual machine VM2 and are assigned to the network interface(s) on the latter physical computer system as appropriate. The advantage here is that a routing from the administration computer system 7 does not need to be altered, but rather allowance can continue to be made for alias IP addresses as a destination, the alias IP addresses being assigned to the actual end points (physical computer system 2b or virtual machine VM2 in the physical computer system 2b as shown in FIG. 5B).

In this manner, it is a simple and convenient matter to migrate virtual machines between physical computer systems within the computer network infrastructure shown.

FIG. 6A shows a further example of a computer network infrastructure comprising two physical computer systems 2a and 2b connected via physical networks N1 and N2. Further, an administration computer system 7 and a broker computer system 8 are provided in the network N1. The networks N1 and N2 may be separate networks or parts of one network. In this respect, the computer network infrastructure is essentially consistent with the design according to the example in FIG. 4. However, the topology of the virtual machines is differing in comparison with the infrastructure shown in FIG. 4.

In the example shown in FIG. 6A, the virtual machines are set up specifically as web servers, application servers and database servers. Two virtual machines web1 and web2 provide web server functionalities. web1 is installed on the physical computer system 2a and web2 on the physical computer system 2b. The two virtualized web servers web1 and web2 can communicate via a communication subnetwork 3c in accordance with the measures explained above. The two web servers web1 and web2 may be addressable from the external network, e.g., from the network N2, directly (immediately) from the outside, e.g., via IP addresses independent of the physical computer systems 2a and 2b. In this manner, these are externally contactable virtual web servers. Nevertheless, a connection from the external network (N1 or N2) to the physical computer systems 2a and 2b via the network ports 4a and 4b is blocked, as already explained above in regard to FIG. 1. Further, two virtualized application servers app1 and app2 are installed on the physical computer systems 2a and 2b that communicate with one another and with the web servers web1 and web2 via a second communication subnetwork 3b. Finally, two virtualized database servers db1 and db2 are also installed on the physical computer system 2a and the physical computer system 2b that communicate with one another and with the application servers app1 and app2 via a third communication subnetwork 3a. Preferably, neither the application servers app1 and app2 nor the database servers db1 and db2 are linked to the external network (N1 or N2).

In this manner, such a computer network infrastructure can be used to produce a complex virtualized network functionality. The two physical computer systems 2a and 2b act to a certain extent as host servers for providing the depicted network services, which, apart from any access to the web servers web1 and web2 externally (as explained above), can communicate via separate communication subnetworks 3a to 3c in completely encapsulated fashion, however. The data interchanged via the communication subnetworks 3a to 3c are relayed via the physical networks N1 and N2 exclusively in encrypted form by VPN connections. Connection attempts from the external networks N1 and N2 directly to the physical host servers 2a and 2b that are independent of relaying of the communications between the virtualized systems, are prevented at the network ports 4a and 4b of the physical host servers 2a and 2b. In this manner, the host servers 2a and 2b are likewise separated from the networks N1 and N2.

With reference to the virtualized applications, security rules, i.e., firewall rules FW, can be allocated at the level of the basic operating system or hypervisor for the individual virtual machines specifically. In this manner, a fine granularity of security settings between the various applications is possible. Therefore, for each communication subnetwork, separate security rules can be set up that may advantageously be independent of other security rules. In particular, it is not necessary to specifically protect the virtualized applications from the outside via firewalls. A security barrier to the networks N1 and N2 is provided by the virtualization, with the hypervisors on the host servers 2a and 2b blocking establishment of a connection from the virtual machines to the networks N1 and N2. In this manner, the computer network infrastructure shown in FIG. 6A is highly structured and flexible in its implementation and adaptation to suit particular application-specific functionalities and nevertheless offers simple administration from the point of view of system security.

An equivalent circuit diagram for the topology shown in FIG. 6A is depicted in FIG. 6B. The individual communication subnetworks therein are denoted by LAN0 to LAN2.

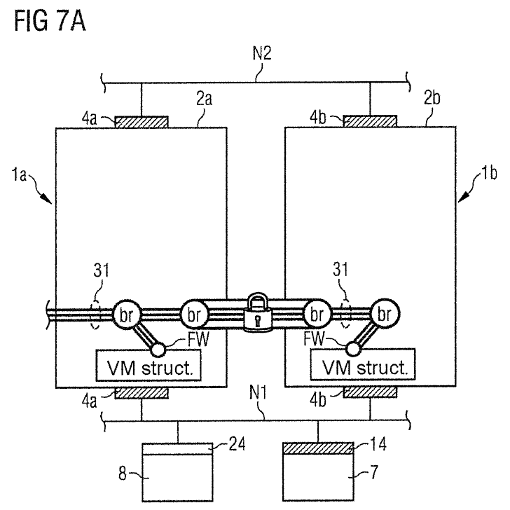

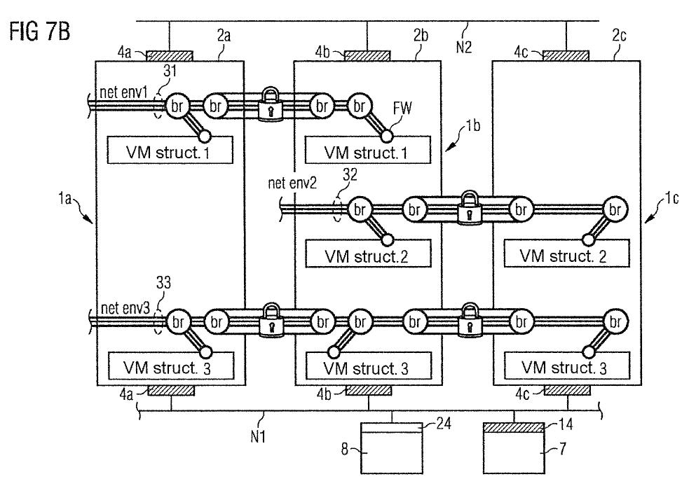

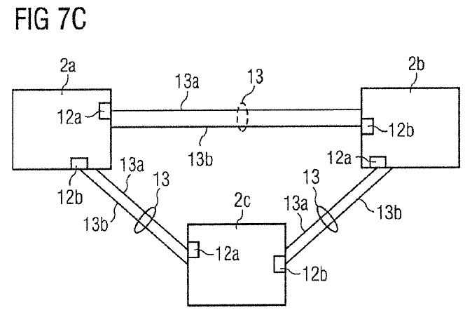

FIG. 7A shows the topology shown in FIG. 6A in a simplified depiction. In this case, the individual virtual machines on the physical host servers 2a and 2b are combined as virtual structures VMStruct. and communicate between the physical host servers 2a and 2b via bridged communication subnetworks 31. FIG. 7B shows an extended example of a computer network infrastructure of the type explained. In this case, three physical host servers 2a, 2b and 2c are set up that comprise applicable computer system architectures 1a having different virtual structures. A first virtual structure VM-Struct.1 is set up on the physical host servers 2a and 2b and communicates via one or more communication subnetworks 31. A second virtual structure VMStruct.2 is set up on the physical host servers 2b and 2c and communicates via one or more communication subnetworks 32. A third structure VM-Struct.3 is set up on the three physical host servers 2a, 2b and 2c and communicates via one or more virtual communication subnetworks 33. The computer network infrastructure shown in FIG. 7B clarifies a flexible extendability of virtualized subnetworks in the computer system architectures explained, which means that very complex application scenarios are realizable despite a very high level of security for the computer network infrastructure.

FIG. 7C shows a topology of VPN connections between the individual physical host servers 2a, 2b and 2c, which may be set up according to the infrastructure from FIG. 7B. Two respective VPN connections are set up between two respective physical host servers. The VPN connections are used to relay the communications along the individual communication subnetworks (cf. 31, 32 and 33 as shown in FIG. 7B). In FIG. 7C, a first VPN connection 13a and a second VPN connection 13b are respectively set up between two respective host servers. The physical host server 2a provides a VPN service 12a on the first VPN connection to the physical host server 2b. Conversely, the physical host server 2b provides a VPN service 12b on the second VPN connection 13b to the physical host server 2a. 12a and 12b may be what are known as VPN daemons, for example. The VPN daemons 12a and 12b can be used to set up the two VPN connections 13a and 13b between the two physical host servers 2a and 2b. An analogous topology is set up between the two physical host servers 2a and 2c and 2b and 2c, respectively. Each of the physical host servers provides a respective VPN service that can be accessed from the outside to set up a VPN connection. In this manner, two redundant VPN connections are realized between two respective physical host servers. If a VPN service on one physical host server fails, for example, then the other VPN connection can continue to be used between physical host servers that are involved. It is naturally possible to provide more (or else fewer) than two VPN connections between two respective physical host servers. All of the VPN connections between the individual physical systems may be set up as bonded, aggregated connections. In this manner, a highly available VPN connection is realizable between the individual physical host servers of a computer network infrastructure of the type explained.

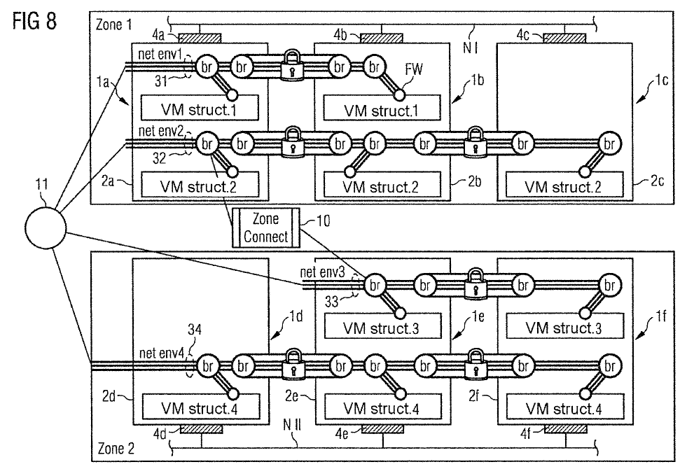

FIG. 8 shows a further example of a computer network infrastructure that is set up according to a systematology of the example shown in FIG. 7B. However, in the topology shown in FIG. 8, a distinction is drawn between two security zones Zone 1 and Zone 2. In each zone there are computer system architectures with physical host servers on which virtual structures that produce virtual application-specific functionalities are set up. Between different physical host servers, the virtual structures communicate via appropriately set-up virtual communication subnetworks. The use of different physical host servers can be used, for example, to map the security zones Zone 1 and Zone 2, which can be made available, e.g., to different customers of a computer center, by separate hardware.

In Zone 1, three physical host servers 2a, 2b and 2c are set up, with a first virtual structure VM-Struct.1 being implemented on the physical host servers 2a and 2b and communicating via virtual communication subnetworks 31. Further, in Zone 1, a virtual structure VM-Struct.2 is set up that is implemented on the three physical host servers 2a, 2b and 2c and is connected via virtual communication subnetworks 32.

In Zone 2, three physical host servers 2d, 2e and 2f are likewise set up with two virtual structures VM-Struct.3 between the physical host servers 2e and 2f and VM-Struct.4 between all three physical host servers 2d, 2e and 2f The virtual structure VM-Struct.3 communicates via virtual communication subnetworks 33, while the virtual structure VM-Struct.4 communicates via virtual communication subnetworks 34.

So that the various virtual structures are if need be contactable externally, that is to say via the Internet or an intranet (if desired and set up, cf. explanations pertaining to FIG. 6A), for example, a forwarding 11 (possibly with IP address conversion, what is known as network address translation, NAT) or a routing to the points of intersection (e.g., web server, cf. FIG. 6A) of the individual communication subnetworks 31, 32, 33 and 34 is set up. The forwarding 11 may be set up via one or more virtualized routers within the virtual environments of the physical host servers 2a to 2f, for example. It is also possible to realize corresponding forwarding via one or more basic operating systems of the physical host servers 2a to 2f A further possible option would also be forwarding via an external physical router. The forwarding 11 can be relayed to the communication subnetworks 31, 32, 33 and 34 by one or both of two external networks NI and NII. In this case too, as already explained repeatedly for the other examples, VPN connections can advantageously be provided so that data are interchanged exclusively in encrypted fashion via the external networks NI and NII.

To connect different structures across the security zones or else as a connection between two structures within one security zone, a relay system 10 (“Zone Connect”) is set up that can be incorporated into individual virtual communication subnetworks via virtual bridges br. The relay system 10 may be a bridge or a router, possibly in combination with a firewall. In FIG. 8, the relay system 10 is linked by way of example to the virtual bridges br of the virtual communication subnetworks 32 in Zone 1 and 33 in Zone 2. In this manner, the two communication subnetworks 32 and 33 can be more or less connected to form a virtual communication subnetwork. In this manner, it is very easily possible to interchange information between individual virtual machines of individual virtual structures via bridged network connections by the relay system 10. On a virtual level, individual virtual machines of different virtual structures can therefore address one another in a simple manner. By way of example, as depicted in FIG. 8, virtual machines from the virtual structure VM-Struct.2 in Zone 1 can directly address virtual machines in the virtual structure VM-Struct.3 in Zone 2. Advantageously, the connection between the two security zones Zone 1 and Zone 2 is protected via the relay system 10 by specific firewall rules, packet filters and the like. The connection can be relayed between the two security zones Zone 1 and Zone 2 via the relay system 10 by one or both of the external networks NI and NII. In this case too, as already explained repeatedly for the other examples, VPN connections can advantageously be provided so that data are interchanged via the external networks NI and NII in exclusively encrypted fashion.

The computer system architectures and computer network infrastructures comprising a plurality of such computer system architectures that have been explained combine various systematologies, as are known in part from conventional solutions, to produce a totally new overall solution. This achieves encapsulation of potentially unsafe operating systems and potentially unsafe application programs running thereon in virtual machines and virtual structures. In this manner, unwanted establishment of a connection from potentially unsafe systems within the virtual machines to external networks is prevented without global firewall rules needing to be set up and administrated for each operating system or each application program within the virtual structures. At the same time, the physical computer systems on which the virtual machines and virtual structures are implemented are protected against establishment of a connection to the physical computer system from the external physical networks, in so far as such establishment of a connection differs from pure relaying of a communication between the virtual machines of different physical computer systems.

In this manner, a computer system architecture or a computer network infrastructure designed therefrom is also specifically protected against attacks from the outside. Nevertheless, the individual physical computer systems as physical host servers provide virtualized application-specific functionalities that can be combined via virtualized communication subnetworks to produce very complex networks. A communication is relayed between virtual communication subnetworks of this kind by external physical networks, in particular in a fashion advantageously protected via encrypted VPN connections. In particular, redundant, bonded VPN connections are used.

All of the topologies of the examples explained can be augmented, extended or altered using features of other topologies. Structurally identical or similar features of the various examples can be used in other examples accordingly. The depicted examples are merely by way of example.

In examples that are not depicted, it is also possible to accommodate virtual machines (VM Guest) in hosting virtual machines (VM Host), the measures of the type explained being used in combination with physical computer systems analogously for the accommodated virtual machines (VM Guest) in the hosting virtual machines (VM Host) and for the hosting virtual machines (VM Host) themselves. In particular, encapsulation of virtual machines within virtual communication subnetworks of the type explained can be applied to hosting virtual machines (VM Host) and accommodated virtual machines (VM Guest). The physical computer systems are protected in this case too, as explained such that establishment of a connection from an external physical network from outside a physical computer system to the physical computer system independently of a virtual communication subnetwork is prevented.

Advantageously, the physical computer systems are generally protected against physical manipulations in high-security racks. Further, it is advantageous to protect any access to software or hardware by administrators using a many-eyes principle.

1-11. (canceled)

12. A computer system architecture comprising a physical computer system on which a basic operating system and a virtual environment are set up, wherein the virtual environment has at least one virtual machine and at least one virtual network bridge of at least one virtual communication subnetwork,
the virtual machine and the virtual network bridge are controllable by the basic operating system,
the virtual machine is linked to the virtual network bridge and set up for communication with further virtual machines within the virtual communication subnetwork,
the virtual machine is further set up such that establishment of a connection from the virtual machine to an external physical network outside the physical computer system, which has a different configuration than the virtual communication subnetwork, is prevented, and
the network ports of the physical computer system are set up such that relaying of a communication between the virtual machine and other virtual machines within the virtual communication subnetwork beyond the physical computer system by the external physical network (N, N1, N2) is permitted,
but establishment of a connection from the external physical network from outside the physical computer system to the physical computer system independently of the virtual communication subnetwork is prevented.

13. The computer system architecture according to claim 12, wherein the virtual environment further has at least one virtual storage interface, the virtual storage interface is controllable by the basic operating system and set up to provide physical storage components as virtual storage components for the virtual machine, and
the virtual machine is linked to the virtual storage interface and set up for communication with the virtual storage components.

14. The computer system architecture according to claim 12, wherein the basic operating system and the virtual environment are set up such that establishment of a connection from the virtual machine to the basic operating system is prevented, but establishment of a connection from the basic operating system to the virtual machine is permitted.

15. The computer system architecture (1) according to claim 12, wherein the basic operating system is set up to encrypt data of the virtual machine that are relayed to outside the physical computer system by the external physical network.

16. A computer network infrastructure comprising a plurality of computer system architectures according to claim 12 connected via at least one physical network,
wherein at least one virtual machine of the respective computer system architectures connects to at least one virtual machine of at least one other computer system architecture via at least one virtual communication subnetwork, and
the computer network infrastructure is set up such that a communication within the at least one virtual communication subnetwork is relayed between the physical computer systems by the at least one physical network.

17. The computer network infrastructure according to claim 16, further comprising physical storage components that store data of the virtual machines of the computer system architectures, wherein the storage components can be addressed as virtual storage components by at least some of the virtual machines.

18. The computer network infrastructure according to claim 16, wherein the computer network infrastructure is set up such that a communication within the at least one virtual communication subnetwork is relayed between the physical computer systems via one or more virtual private networks.

19. The computer network infrastructure according to claim 18, wherein at least a first and a second virtual private network that relay the at least one virtual communication subnetwork are set up between two respective physical computer systems, and an addressable VPN service of the first virtual private network is set up on one physical computer system and an addressable VPN service of the second virtual private network is set up on the other physical computer system.

20. The computer network infrastructure according to claim 16, wherein multiple separate virtual communication subnetworks are set up and separate security rules for the virtual machines involved are prescribed for each virtual communication subnetwork.

21. The computer network infrastructure according to claim 20, wherein a routing is set up between the different virtual communication subnetworks so that communication between virtual machines of different communication subnetworks is rendered possible.

22. The computer network infrastructure according to claim 16, further comprising an administration computer system and a broker computer system connected to the at least one physical network for administration of one or more computer system architectures,
wherein the network ports of the administration computer system are closed toward the at least one physical network so that establishment of a connection from the at least one physical network from outside the administration computer system to the administration computer system is prevented, but wherein the broker computer system has at least one open network port toward the at least one physical network and is set up such that both the administration computer system and the physical computer systems of the computer system architectures to be administrated can access the broker computer system via the at least one physical network.
